(19) United States
(12) Patent Application Publication
(10) Pub. No.: US 2005/0029867 A1
(43) Pub. Date: Feb. 10, 2005

(54) Energy management system for vehicle

(76) Inventor: Steven J. Wood, Shorewood, WI (US)

Correspondence Address: FOLEY & LARDNER, 777 EAST WISCONSIN AVENUE, SUITE 3800, MILWAUKEE, WI, 53202-5308, US

(21) Appl. No.: 10/489,240

(22) PCT Filed: Sep. 10, 2002
(86) PCT No.: PCT/US02/28791

Related U.S. Application Data
(60) Provisional application No. 60/318,512, filed on Sep. 10, 2001.

(51) Int. Cl. B60L 1/00; B60L 3/00

(52) U.S. Cl. 307/10.1; 307/10.7; 307/66

(57) ABSTRACT

A module for managing power in an electrical system of a vehicle is disclosed. The module includes a first interface configured for coupling to a first power source. The first power source is configured to power a plurality of loads of the electrical system. The module also includes a second interface configured for coupling to a second power source. The second power source is configured for charging the first power source. The module also includes a device configured for disconnecting the first power source from the plurality of loads. The device is also configured for disconnecting the second power source from the first power source.

### CROSS-REFERENCE TO RELATED PATENT APPLICATIONS

The following U.S. patent applications are hereby cross-referenced and incorporated by reference: U.S. Provisional Patent Application No. 60/318,512 titled “Energy Management System For Vehicle” filed Sep. 10, 2001.

### FIELD

The present invention relates to an energy management system for a vehicle. The present invention more specifically relates to a module for managing the energy and power in the electrical system of a vehicle.

### BACKGROUND

It is generally known to provide for a system for disconnecting a battery from a load of an electrical system of a vehicle. According to such known system, a controller manipulates a switching mechanism between a closed position and an opened position. In the closed position the switching mechanism connects the load to the battery, and in the opened position the switching mechanism disconnects the load from the battery. However, such known system has several disadvantages including that certain loads may remain connected to the battery when the switching mechanism is manipulated to the opened position. Further, such known system is not readily adaptable to an electrical system of a vehicle having loads of multiple voltages.

Accordingly, it would be advantageous to provide a module for managing power in an electrical system of a vehicle. It would also be advantageous to provide a module having short circuit protection in an electrical system having loads of multiple voltages. It would also be advantageous to provide a module having interfaces for assistance in jump-starting a vehicle. It would be desirable to provide for an energy management system for a vehicle having one or more of these or other advantageous features.

### SUMMARY OF THE INVENTION

The present invention relates to a module for managing power in an electrical system of a vehicle. The module includes a first interface configured for coupling to a first power source. The first power source is configured to power a plurality of loads of the electrical system. The module also includes a second interface configured for coupling to a second power source. The second power source is configured for charging the first power source. The module also includes a device configured for disconnecting the first power source from the plurality of loads. The device is also configured for disconnecting the second power source from the first power source.

The present invention also relates to a module for managing power in an electrical system of a vehicle. The module includes a first means for coupling to a first power source. The first power source is configured to power a plurality of loads of the electrical system. The module also includes a second means for coupling to a second power source. The second power source is configured for charging the first power source and is configured for powering the plurality of loads. The module also includes a device. The device includes a first means for disconnecting the first power source from the plurality of loads. The device also includes a second means for disconnecting the second power source from the plurality of loads and for disconnecting the second power source from the first power source.

The present invention also relates to a module for managing power in an electrical system of a vehicle. The module includes a first interface configured for coupling a first low voltage battery to a first high voltage battery. The module also includes a second interface configured for coupling a second high voltage battery to the first high voltage battery and to a plurality of high voltage loads. The module also includes a third interface configured for coupling a second low voltage battery to a plurality of low voltage loads. The module also includes a fourth interface configured for coupling the first high voltage battery to the plurality of high voltage loads. The module also includes a DC-to-DC converter configured to accept a low current input from the first low voltage battery and to provide a high current output to charge the first high voltage battery. The module also includes a switch for disconnecting the low voltage loads from each of the first and second low voltage batteries and configured for disconnecting the high voltage loads from each of the first and second high voltage batteries.

### DESCRIPTION OF THE FIGURES

FIG. 1A is a front perspective view of an energy management system for a vehicle according to an exemplary embodiment.

FIG. 1B is a rear perspective view of the energy management system of FIG. 1A.

FIG. 2A is a schematic block diagram of a control system having an energy management system for a vehicle according to an exemplary embodiment.

FIG. 2B is a schematic block diagram of the control system of FIG. 2A according to an alternative embodiment.

FIG. 3A is a schematic block diagram of a control system having an energy management system for a vehicle according to an exemplary embodiment.

FIG. 3B is a schematic block diagram of the control system of FIG. 3A according to an alternative embodiment.

FIG. 3C is a schematic block diagram of the control system of FIG. 3A according to an alternative embodiment.

### DETAILED DESCRIPTION OF PREFERRED AND OTHER EXEMPLARY EMBODIMENTS

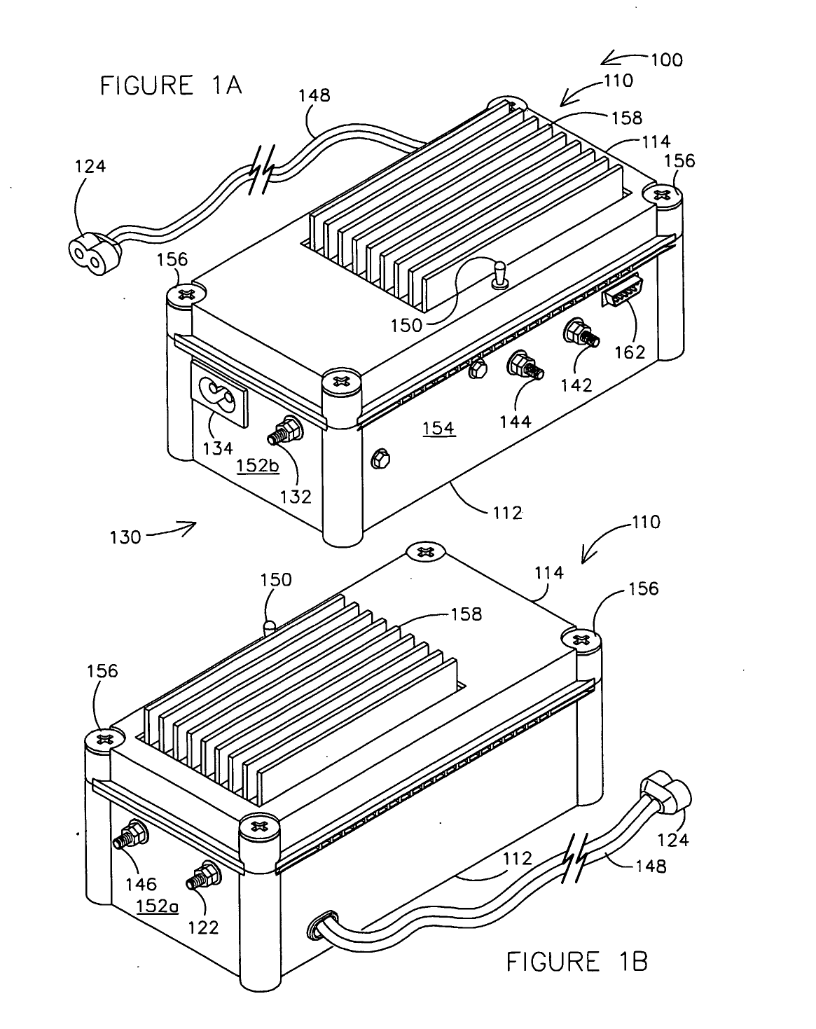

An energy management system 100 is shown in FIGS. 1A and 1B according to an exemplary embodiment. Energy management system 100 includes interfaces 122 and 124 for mechanical and electrical connection of a power source or battery system 20 to loads of an electrical system 30 of a vehicle. Energy management system 100 also includes a jump assistance system 130 having interfaces 132 and 134 for mechanical and electrical connection to an auxiliary power source 80 such as a battery. Auxiliary power source 80 provides for “jump assistance” or the jump-starting of the vehicle in the event that battery system 20 does not have sufficient charge to start the vehicle.

Energy management system 100 also provides “short circuit” (i.e. a low-resistance connection unintentionally established between two points in an electric circuit) protection of battery system 20. A short circuit could occur, for example, if a load (or loads) of electrical system 30 fail and such load draws a current that is greater than a predetermined value. A short circuit could also occur, for example, if auxiliary power source 80 is connected to energy management system 100 with an incorrect polarity (e.g. reverse polarity, negative voltage, etc.). A short circuit could also occur, for example, if auxiliary power source 80 is connected to energy management system 100 with a voltage that is greater or less than a predetermined value (e.g. greater than about 42 volts).

In such situations, loads of electrical system 30 are disconnected from battery system 20 and/or auxiliary power source 80. Disconnection of such loads assists in inhibiting “arcing” of current. A system disconnect device or switch (shown as a hinged toggle switch 150 manually operable between an “on” and “off position”) also serves to disconnect or remove battery system 20 and auxiliary power source 80 from the loads of electrical system 30. Switch 150 may be opened, for example, to allow a technician to service the vehicle, the battery system, the electrical system, etc.

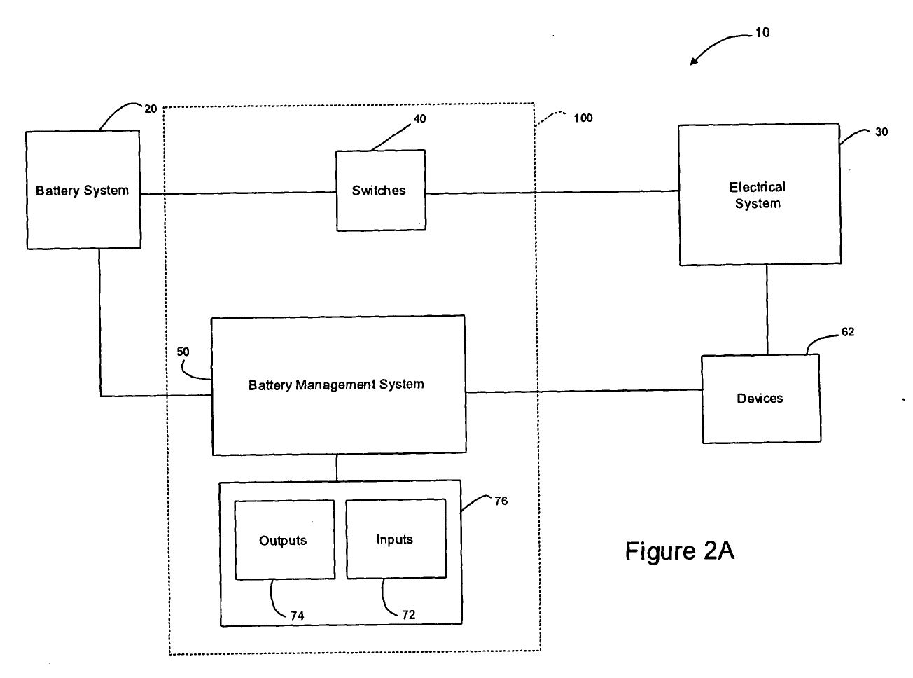

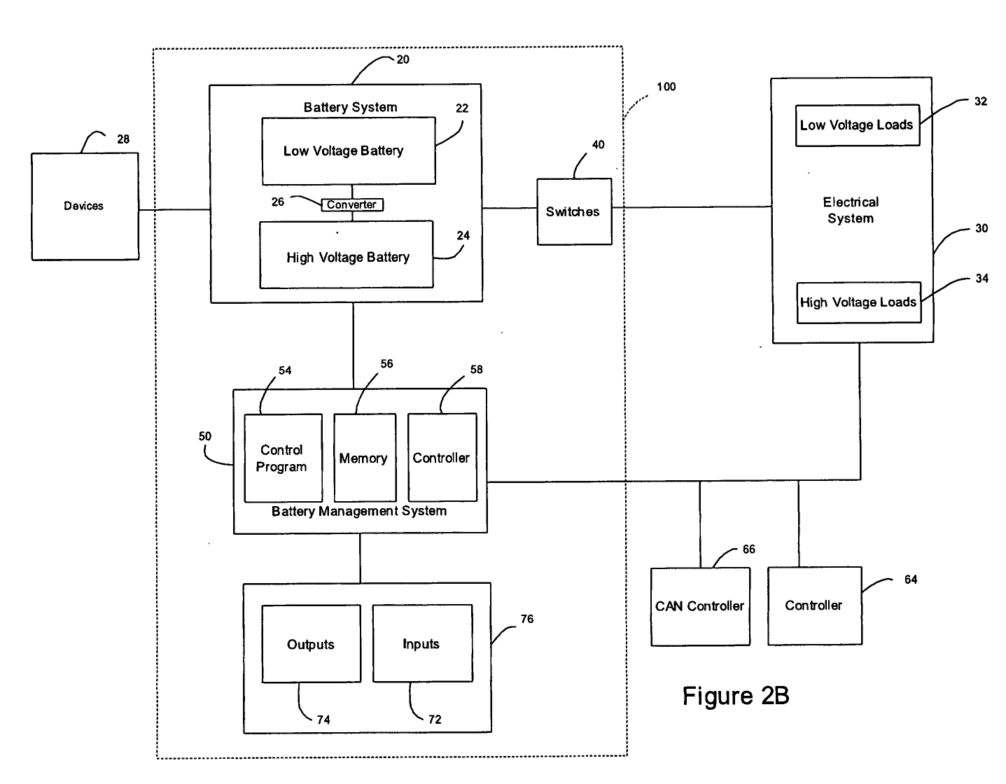

Referring further to FIGS. 1A and 1B, energy management system 100 is shown including a container or module 110 having a base 112 attached to a cover 114 by a fastener (shown as a screw 156). Energy management system 100 includes interface 122 (shown as a terminal post extending from an end wall 152a) for mechanical and electrical attachment to the terminal of a low voltage battery 22 (e.g. 12 volt, 14 volt, etc. as shown in FIG. 2B). A mounting interface shown as a terminal post 142 extends from a side wall 154 of base 112. Post 142 mechanically and electrically attaches low voltage battery 22 to low voltage loads 32 of electrical system 30 (see FIG. 2B).

Energy management system 100 also includes interface 124 (shown as a female connector or socket attached to a cable or wire 148) for mechanical and electrical attachment to the terminal of a high voltage battery 24 (e.g. 24 volt, 36 volt, 42 volt, etc. as shown in FIG. 2B). A mounting interface shown as a terminal post 144 extends from side wall 154 of base 112. Post 144 mechanically and electrically attaches high voltage battery 24 to high voltage loads 34 of electrical system 30 (see FIG. 2B).

Energy management system 100 also includes jump assistance system 130 for mechanical and electrical attachment of auxiliary power source 80 to either of low voltage battery 22 or high voltage battery 24. A mounting interface shown as a male connector or prong 134 extends from an end wall 152b of base 112 as shown in FIG. 1A. The vehicle can be “jumped” or started by mechanical and electrical attachment of a high voltage auxiliary power source 84 (such as a 36 volt or 42 volt battery from a vehicle providing a jump start) to prong 134.

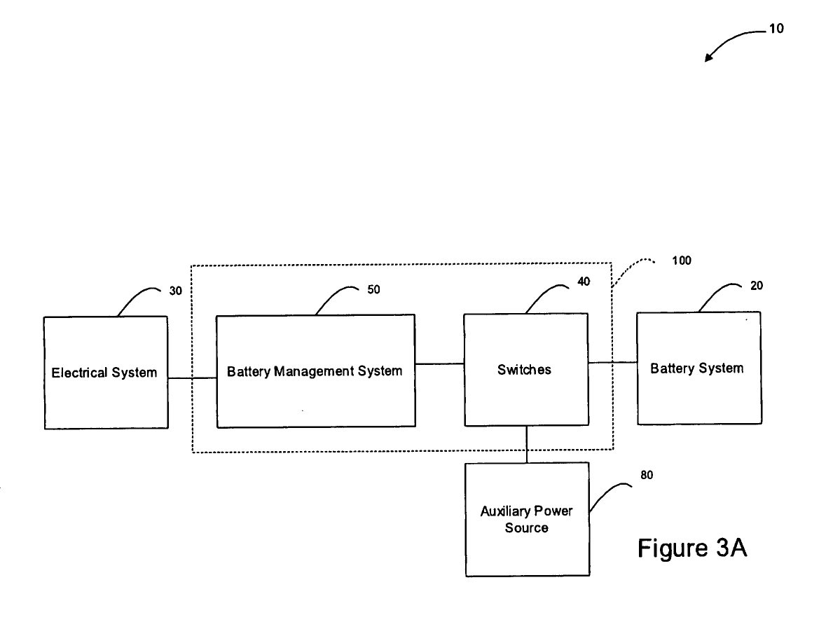

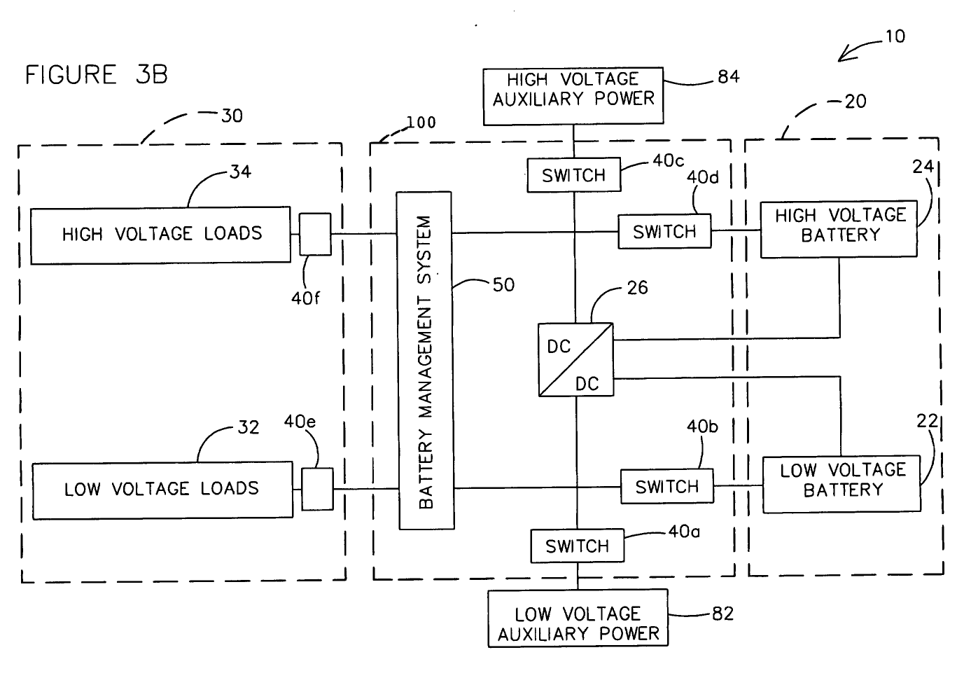

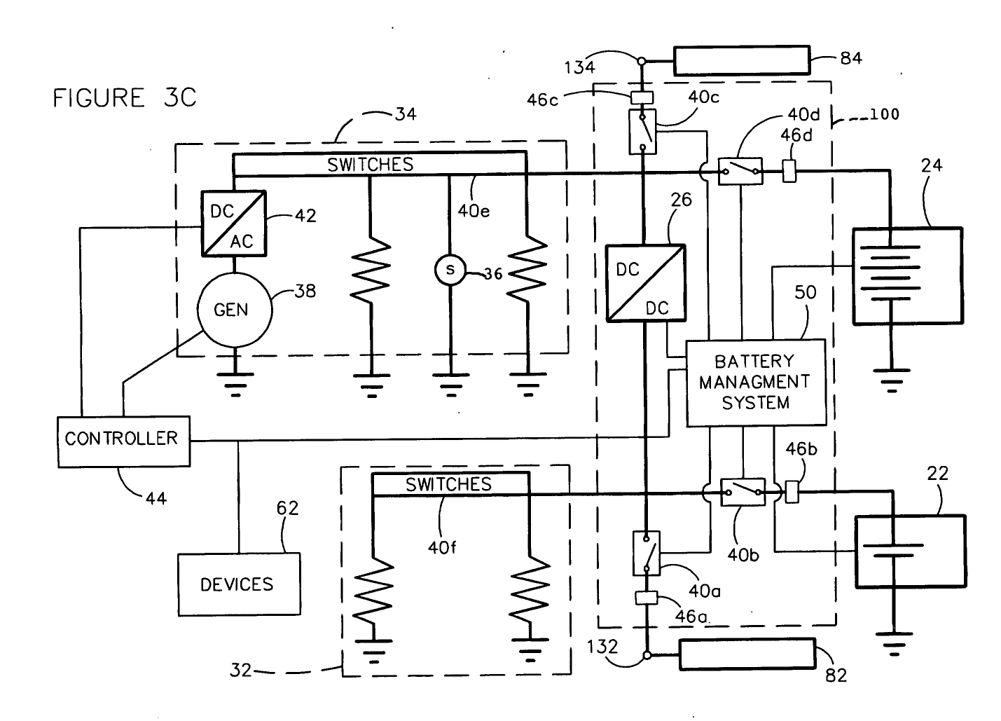

A mounting interface shown as a terminal post 132 in FIG. 1A extends from end wall 152b of base 112. Post 132 is attached to a converter (shown as a DC-to-DC converter 26 in FIG. 3B). Converter 26 includes a heat exchanger shown as “fins” or flanges 158. In general, the starting of the vehicle can be aided by mechanical and electrical attachment of a low voltage auxiliary power source 82 (such as a 12 volt or 14 volt battery from a jump vehicle) to post 132. A mounting interface shown as a post 146 (connected to ground) is provided on end wall 152a for mechanical and electrical connection to the negative terminal of low voltage battery 22 when jumping the vehicle.

Referring to FIG. 2A, a schematic block diagram of a control system 10 having energy management system 100 for the vehicle is shown according to an exemplary embodiment. Battery system 20 powers loads of electrical system 30 of the vehicle. A battery management system 50 provides commands or outputs 74 to open and close switches 40 to selectively connect and disconnect battery system 20 from the loads of electrical system 30. Disconnection of such loads may preserve the charge of battery system 20. The preservation of charge of battery system 20 can extend the useful life of battery system 20 and the duration of time the vehicle may be driven before stopping in a location to obtain service (e.g. recharging or replacing the battery system).

Certain loads of the vehicle (such as a starter 36 to crank the engine of the vehicle as shown in FIG. 3C) may be disconnected from the battery system 20 if battery management system 50 determines the occurrence of an unauthorized event (e.g. unauthorized entry of the vehicle, unauthorized access to the vehicle, bypass of the battery, etc.) according to an alternative embodiment. Certain loads of the vehicle (e.g. starter) may also be disconnected if the battery management system determines the impact of the vehicle likely occurred (e.g. excess vibration, deceleration, discharge of airbags, etc.) according to another alternative embodiment.

Battery system 20 includes low voltage battery 22 for low voltage loads 32 and high voltage battery 24 for high voltage loads 34 as shown in FIG. 2B. The loads of electrical system 30 include any module or device of the vehicle that is powered by battery system 20. The high voltage loads may include a vehicle starter, ignition, fuel pump, alternator, generator, electric steering system, electric braking system, active suspension, heater, etc. according to any preferred or alternative embodiment. The low voltage loads may include a lighting system, blower, fan, heating and cooling system, air conditioning system, accessory such as radio, windshield washing system, adapter outlet, cigarette lighter, etc. according to any preferred or alternative embodiment.

Converter 26 is electrically connected to low voltage battery 22 and high voltage battery 24 as shown in FIG. 2B. Converter 26 can accept an input current (e.g. from an alternator, low voltage battery, high voltage battery, reserve or auxiliary battery, etc.) to produce an output current to charge low voltage battery 22 or high voltage battery 24. Converter “boosts” or increases a DC current provided by low voltage battery 22 (or low voltage auxiliary power source 82) to charge a high voltage battery 24. Converter “bucks” or decreases a DC current provided by high voltage battery 24 (or high voltage power auxiliary source 84) to charge a low voltage battery 22. Conversion of the current may be provided by high frequency switching action employing inductive and capacitive filter elements. The converter is a 42 volt/14 volt 1.0 kW bidirectional DC-to-DC converter according to a particularly preferred embodiment.

Other devices 28 may charge battery system 20 and/or power the loads of electrical system 30 according to an alternative embodiment as shown in FIG. 2B. Such other devices 28 can include an alternator (or generator 38 as shown in FIG. 3C) that provides an electric current for recharging battery system 20 according to any preferred or alternative embodiment. Such other devices 28 can also include a reserve or auxiliary battery for powering the loads in the event that the battery system does not have a sufficient charge to power the loads according to an alternative embodiment.

Devices or switches 40 break or open an electric circuit or otherwise divert current from battery system 20 to the loads of electrical system 30 as shown in FIG. 2A. Each load (or group of loads) of electrical system 30 is associated with a device or switch according to a preferred embodiment (see FIG. 3C). Battery management system 50 commands switches 40 to open to disconnect certain loads from battery system 20, and commands switches 40 to close to connect (or reconnect) certain loads to battery system 20.

Signals or inputs 72 representative of a condition or state of battery system 20, electrical system 30 or auxiliary power source 80, are provided to battery management system 50 by an information system. The information system includes sensors (shown as sensors 46a, 46b, 46c and 46d in FIG. 3C) associated with energy management system 100 to provide inputs 72 to battery management system 50 that are representative of a condition of battery system 20, electrical system 30 or auxiliary power source 80. The inputs representative of a condition of the loads of the electrical system may include whether a load is “on” or “off,” the speed of the vehicle, the temperature of a component, etc. according to any preferred or alternative embodiment. The inputs representative of a condition of the battery system or the auxiliary power source may include voltage, current drawn by loads, resistance, temperature, time, period since last discharge, whether a jump-start of the vehicle has been attempted, etc.) according to any preferred or alternative embodiment.

Based on inputs 72, battery management system 50 provides outputs 74 (e.g. state of charge, state of health and capability, deliverable energy, deliverable power, capacity, battery condition, etc.) intended to manage operation of battery system 20 (e.g. battery “management”). One output provided by battery management system 50 includes a command provided to switches 40 to disconnect certain loads of electrical system 30 from battery system 20 and/or auxiliary power source 80. Another output includes the providing of information to another vehicle subsystem (e.g. vehicle controller, communications network, etc.). Another output includes providing information to a display of a user interface 76. The information may be displayed on a screen (such as a report) or by an indicator (such as a light or LED). The output can also be an audible signal according to an alternative embodiment.

Inputs 72 may also be provided to battery management system 50 by other devices 62 (see FIG. 2A) such as a vehicle controller 64 or controller area network (CAN) controller 66 (see FIG. 2B). Inputs 72 may also be provided directly to battery management system 50 through user interface 76 or otherwise acquired (e.g. RF signal) as shown in FIGS. 2A and 2B.

As shown in FIG. 2B, inputs 72 may also be provided to battery management system 50 by a network having vehicle controller 64 and CAN controller 66. The network includes a CAN network or CANbus according to a preferred embodiment, and may include other suitable networks for providing information about the loads such as a J1850 VPW network, ISO9141/Keyword 2000 network, etc. according to alternative embodiments. Battery management system 50 is connected to the network by an input/output (I/O) port 162 (see FIG. 1A) for the exchange of information with the network according to an alternative embodiment.

Battery management system 50 includes a controller 52 for running a control program 54 that is implemented by software. Control program 54 may reside in a memory 56 or on hardware. Control program 54 comprises routines (e.g. programs, algorithms, logic, set sequence of steps, calculations, etc.) using inputs 72 to provide outputs 74.

Referring to FIG. 3A, control system 10 having energy management system 100 is shown according to an exemplary embodiment. Battery management system 50 of energy management system 100 provides commands to open and closes switches 40 to selectively connect and disconnect battery system 20 and auxiliary power source 80 with electrical system 30. (Energy management system 100 may include battery system 20 as shown according to an alternative embodiment in FIG. 2B.)

Referring to FIG. 3B, control system 10 having energy management system 100 is shown according to an exemplary embodiment. Control system 10 includes battery system 20 having low voltage battery 22 for low voltage loads 32 and high voltage battery for high voltage loads 34.

Energy management system 100 also includes jump assistance system 130. Referring further to FIG. 3B, jump assistance system 130 includes low voltage auxiliary power source 82 for low voltage loads 32 and for providing a low current to converter 26 for charging high voltage battery 24. Jump assistance system 130 also includes high voltage auxiliary power source 84 for high voltage loads 34 and for charging high voltage battery 24.

A device or switch 40a under the control of battery management system 50 disconnects low voltage auxiliary power source 82 from low voltage loads 32 in certain situations. Such situations include, for example, when battery management system 50 makes a determination that low voltage auxiliary power source 82 is connected in reverse polarity to post 132, a low voltage (e.g. less than about 0 volts) provided by low voltage auxiliary power source 82, an excessive voltage (e.g. greater than about 14 volts) provided by low voltage auxiliary power source, etc.

A device or switch 40b under control of battery management system 50 disconnects low voltage loads 32 from low voltage battery 22 in certain situations. Such situations include, for example, when battery management system 50 makes a determination that one or all of low voltage loads 32 draw an excessive current (e.g. greater than about 70 amps) from low voltage battery 22.

A device or switch 40c under the control of battery management system 50 disconnects high voltage auxiliary power source 84 from high voltage loads 34 in certain situations. Such situations include, for example, when battery management system 50 makes a determination that a reverse polarity or excessive voltage is provided by low voltage auxiliary power source 82. A device or switch 40d under control of battery management system 50 disconnects high voltage loads 34 from high voltage battery 24 in such situations. Such situations include, for example, when battery management system 50 makes a determination that that one or all of the high voltage loads 34 draw an excessive current (e.g. greater than a predetermined current expected from proper operation of the high voltage loads) from high voltage battery 24.

Fuses or switches 40e under control of battery management system 50 and/or vehicle controller 64 associated with each of low voltage loads 32 are also disconnected from low voltage battery 22 if battery management system 50 makes a determination that one or all of low voltage loads 32 draw an excessive current from low voltage battery 22. Fuses or switches 40f under control of battery management system 50 or vehicle controller 64 associated with each of high voltage loads 34 are also disconnected from high voltage battery 24 if battery management system 50 determines that one or all of high voltage loads 34 draws an excessive current from high voltage battery 24. Switches 40a through 40d may be a single device or switch operable by manual activation of toggle switch 150 according to an alternative embodiment.

Referring further to FIG. 3C, control system 10 having energy management system 100 is shown according to an exemplary embodiment. High voltage loads 34 are shown including starter 36 and generator 38. Generator 38 provides an AC current, which is converted to a DC current by a converter (shown as an AC-to-DC converter 42) to charge high voltage battery 24. Generator 38 and converter 42 may be under control of a power train controller 44 of the vehicle according to an alternative embodiment as shown in FIG. 3C.

Referring further to FIG. 3C, sensor 46a monitors a signal representative of the voltage of the low voltage auxiliary power source 82, and sensor 46c monitors a signal representative of the voltage of the high voltage auxiliary power source 84. Sensor 46b monitors a signal representative of the current drawn from low voltage battery 22 by low voltage loads 32, and sensor 46d monitors a signal representative of the current drawn from high voltage battery 24 by high voltage loads 34. Sensor 46b may also monitor a signal representative of the voltage of low voltage battery 22, and sensor 46d may also monitor a signal representative of the voltage of high voltage battery 24 according to any preferred or alternative embodiments. Sensors 46a through 46d provide inputs 72 to battery management system 50, and battery management system 50 provides outputs 74 to selectively open and close switches 40a through 40d in response to such inputs 72.

To provide “jump aid” to the vehicle (i.e. assisting in jumping the vehicle when the auxiliary power source cannot provide sufficient power to start the vehicle), a positive terminal of low voltage auxiliary power source 82 is connected to post 132. A negative terminal of low voltage auxiliary power source 82 is connected to post 146. Sensor 46a provides to battery management system 50 a signal representative of the voltage of low voltage auxiliary power source 82 (e.g. about 13.4 volts or greater). Battery management system 50 then sends a signal to close switch 40a. On closing switch 40a, a low current is provided from low voltage auxiliary power source 82 to converter 26. Battery management system 50 also sends a signal to close switch 40d. A high current is provided from converter 26 to charge high voltage battery 24, which in turn provides current to starter 36. (The power train controller may also provide a signal to the battery management system that the engine of the vehicle is not running according to an alternative embodiment.)

To provide jump-starting of the vehicle, high voltage auxiliary power source 84 is connected to prong 134. Sensor 46c provides to battery management system 50 a signal representative of the voltage of high voltage auxiliary power source 84 (e.g. about 41 volts or greater). Battery management system 50 then provides a signal to close switch 40c. On closing switch 40c, high voltage auxiliary power source 84 is connected to starter 36. Battery management system 50 also provides a signal to close switch 40d to provide current from high voltage auxiliary power source 84 to charge high voltage battery 24.

During jump aid of the vehicle, the battery management system provides a signal to open certain switches to disconnect certain loads from the low voltage battery and the high voltage battery according to an exemplary embodiment. Battery management system 50 provides a signal to open switch 40b to disconnect low voltage loads 32 from low voltage battery 22. Battery management system 50 also provides a signal (e.g. to devices 62 such as vehicle controller 64 and/or CAN controller 66) to open switches 40f to disconnect low voltage loads 32 from low voltage battery 22. Battery management system 50 provides a signal to open switches 40e to disconnect certain high voltage loads 34 from high voltage battery 24 (e.g. loads such as generator 38 that is not necessary for starting the vehicle). During jump-starting of the vehicle, battery management system 50 provides a signal to open certain of switches 40e to disconnect certain high voltage loads 34 from high voltage battery 24 that are not necessary for starting the vehicle according to an exemplary embodiment.

If sensor 46a indicates that low voltage auxiliary power source 82 is not “compatible” with interface 132 (e.g. is not the appropriate or desired voltage—such as a voltage greater or less than a predetermined voltage, is connected in reverse polarity, provides a negative voltage, provides an excessive voltage, etc.) then battery management system 50 instructs switch 40a to open to disconnect low voltage auxiliary power source 82. If sensor 46c indicates that high voltage auxiliary power source 84 is not is not “compatible” with interface 134, then battery management system 50 instructs switch 40c to open to disconnect high voltage auxiliary power source 84.

If sensor 46b indicates that an auxiliary power source is attached to low voltage battery 22, and that the auxiliary power source has a voltage that is not “compatible” with low voltage battery 22, then battery management system 50 instructs switch 40b to open to disconnect low voltage battery 22. If sensor 46d indicates that an auxiliary power source is attached to high voltage battery 24, and that the auxiliary power source has a voltage that is not “compatible” with high voltage battery 24, then battery management system 50 instructs switch 40d to open to disconnect high voltage battery 24.

Redundant or backup power sources may be provided for certain loads of electrical system 30 (e.g. electric steering, electric braking, electric throttle, etc.), which may decrease the probability of a vehicle “no-start” condition. For example, power may be provided from one battery (e.g. low voltage battery) to the starter if the other battery (e.g. high voltage battery) does not provide sufficient power according to an exemplary embodiment (see FIG. 3C).

If low voltage battery 22 becomes discharged to less than a predetermined value (e.g. a 50 percent “state of charge” i.e. an amount of electrical energy stored in a battery at a given time expressed as a percentage of the energy when fully charged—of about 12.2 volts for a 12 volt battery), low voltage battery 22 may be recharged in a variety of ways. Current may be provided to low voltage battery 22 from low voltage auxiliary power source. Current may also be provided to low voltage battery 22 from high voltage auxiliary power source 84 though converter 26. Current may also be provided to low voltage battery 22 from high voltage battery 24 through converter 26. Current may also be provided from a low voltage auxiliary power source directly connected to low voltage battery according to an alternative embodiment.

If high voltage battery 24 becomes discharged to less than a predetermined value (e.g. less than about 50 percent “state of charge”), high voltage battery 24 may also be recharged in a variety of ways. Current may be provided to high voltage battery 24 from low voltage auxiliary power source 82 through converter 26. Current may also be provided to high voltage battery 24 from high voltage auxiliary power source 84. Current may also be provided to high voltage battery 24 from low voltage battery 22 through converter 26. Current may also be provided to high voltage battery 24 from generator 38 though converter 42. Current may also be provided from a high voltage auxiliary power source directly connected to low voltage battery according to an alternative embodiment.

The battery system includes a lead-acid battery for an automobile according to a preferred embodiment. A suitable low voltage battery includes a 12 volt or 14 volt absorptive glass mat (AGM) valve regulated lead-acid (VLRA) battery such as a 12 volt Red Top Optima battery commercially available from Optima Batteries, Inc. of Boulder, Colo. Another suitable low voltage battery includes the 12 volt or 14 volt “non-flooded” DieHard battery commercially available from Sears, Roebuck and Co. of Hoffman Estates, Ill. A suitable high voltage battery includes the 36 volt or 42 volt 2.4 amp hour (AH) Inspira battery commercially available from Johnson Controls Battery Group, Inc. of Milwaukee, Wis. The battery system may include three 12 volt batteries connected in series to form a 36 volt battery pack according to an alternative embodiment.

The devices or switches are “solid state” switches comprising primarily semi-conducting materials and components, such as a metal oxide semiconductor field effect transistor (“MOSFET”) according to a preferred embodiment. The switches may be mechanical switches or relays that respond to a current or voltage change to connect and disconnect the loads from the battery system according to an alternative embodiment. The switches may include a manually activated main or system switch to disconnect all loads of the electrical system from the battery system according to another alternative embodiment.

The battery management system may be a computing device, microprocessor, controller or programmable logic controller (PLC) for implementing a control program, and which provides output signals based on input signals provided by a sensor or that are otherwise acquired. Any suitable computing device of any type may be included in the battery management system according to alternative embodiments. For example, computing devices of a type that may include a microprocessor, microcomputer or programmable digital processor, with associated software, operating system and/or any other associated programs to implement the control program may be employed. The controller and its associated control program may be implemented in hardware, software or a combination thereof, or in a central program implemented in any of a variety of forms according to alternative embodiments. A single control system may regulate the controller for the battery management system and the controller for the vehicle according to an alternative embodiment.

It is important to note that the construction and arrangement of the elements of the energy management system for vehicle as shown in the preferred and other exemplary embodiments is illustrative only. Although only a few embodiments of the present inventions have been described in detail in this disclosure, those skilled in the art who review this disclosure will readily appreciate that many modifications are possible (e.g. variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, the module is compatible and scalable with any voltage loads and is adaptable to multiple generator technologies and system capacities according to alternative embodiments. The module may have a size and shape for containing a wide array of different component shapes and sizes according to alternative embodiments. The module may include a number of compartments that may be configured in various orientations (e.g. horizontal, vertical, etc.) and positions (e.g. with respect to the engine or other vehicle systems and components) and/or configured (e.g. shaped and sized) to fit in one or multiple vehicles of different types according to alternative embodiments. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the spirit of the present inventions as expressed in the appended claims.

1. A module for managing power in an electrical system of a vehicle comprising:
a first interface configured for coupling to a first power source, the first power source configured to power a plurality of loads of the electrical system;
a second interface configured for coupling to a second power source, the second power source configured for charging the first power source;
a device between the first power source and the plurality of loads;
wherein the device is configured for disconnecting the first power source from the plurality of loads and the device is configured for disconnecting the second power source from the first power source.

2. The module of claim 1 wherein the first power source comprises a first battery for a first plurality of the loads.

3. The module of claim 2 wherein the first power source further comprises a second battery for a second plurality of the loads.

4. The module of claim 3 wherein the first plurality of the loads comprises a plurality of low voltage loads and the second plurality of the loads comprises a plurality of high voltage loads.

5. The module of claim 4 wherein the first battery comprises a low voltage battery and second battery comprises a high voltage battery.

6. The module of claim 5 wherein the first battery comprises at least one of a 12 volt battery and a 14 volt battery.

7. The module of claim 6 wherein the second battery comprises at least one of 36 volt battery and a 42 volt battery.

8. The module of claim 5 wherein the second power source comprises a first auxiliary power source and a second auxiliary power source.

9. The module of claim 8 wherein the first auxiliary power source comprises at least one of a 12 volt battery and a 14 volt battery and the second auxiliary power source comprises at least one of a 36 volt battery and a 42 volt battery.

10. The module of claim 5 further comprising a converter configured for increasing a current provided by the low voltage battery to the high voltage battery.

11. The module of claim 10 wherein the converter comprises a DC-to-DC converter.

12. The module of claim 5 wherein the device comprises a switch.

13. The module of claim 12 wherein the device comprises a first set of switches configured to disconnect the first battery from the first plurality of loads and configured to disconnect the second battery from the second plurality of loads.

14. The module of claim 12 wherein the device is configured for disconnecting the second power source from the plurality of loads.

15. The module of claim 14 wherein the device further comprises a second set of switches configured to disconnect the first auxiliary power source from the first battery and from the first plurality of loads and also configured to disconnect the second auxiliary power source from the second battery and from the second plurality of loads.

16. The module of claim 10 further comprising a plurality of sensors configured to monitor a signal representative of a condition of the at least one of the first power source and the second power source.

17. The module of claim 16 further comprising a battery management system configured to selectively open and close the device in response to a signal provided by the sensors.

18. The module of claim 17 wherein the battery management system is configured to disconnect at least one of the first auxiliary power source and the second auxiliary power source from the plurality of loads if a voltage provided by at least one of the first auxiliary power source and the second auxiliary power source is less than a predetermined value.

19. A module for managing power in an electrical system of a vehicle comprising:
first means for coupling to a first power source, the first power source configured to power a plurality of loads of the electrical system;
second means for coupling to a second power source, the second power source configured for charging the first power source and configured for powering the plurality of loads;
a device comprising:
first means for disconnecting the first power source from the plurality of loads;
second means for disconnecting the second power source from the plurality of loads and for disconnecting the second power source from the first power source.

20. The module of claim 19 wherein the first power source comprises a low voltage battery for low voltage loads of the plurality of loads and a high voltage battery for high voltage loads of the plurality of loads.

21. The module of claim 20 wherein the second power source comprises a low voltage auxiliary power source for the low voltage loads and for charging the high voltage battery and further comprises a high voltage auxiliary power source for the high voltage loads.

22. The module of claim 21 wherein the first means for disconnecting comprises a first set of switches configured to disconnect the low voltage battery from the low voltage loads and also configured to disconnect the high voltage battery from the high voltage loads.

23. The module of claim 22 wherein the second means for disconnecting comprises a second set of switches configured to disconnect the low voltage auxiliary power source from the low voltage battery and the low voltage loads and also configured to disconnect the high voltage auxiliary power source from the high voltage battery and the high voltage loads.

24. A module for managing power in an electrical system of a vehicle comprising:
a first interface configured for coupling a first low voltage battery to a first high voltage battery;
a second interface configured for coupling a second high voltage battery to the first high voltage battery and to a plurality of high voltage loads;
a third interface configured for coupling a second low voltage battery to a plurality of low voltage loads;
a fourth interface configured for coupling the first high voltage battery to the plurality of high voltage loads;
a DC-to-DC converter configured to accept a low current from the first low voltage battery and to provide a high current to charge the first high voltage battery;
a switch for disconnecting the low voltage loads from each of the first and second low voltage batteries and configured for disconnecting the high voltage loads from each of the first and second high voltage batteries.

25. The module of claim 24 wherein the first interface is a mounting post configured for jump assistance of the vehicle.

26. The module of claim 25 wherein the second interface is a mounting post configured for jump-starting of the vehicle.

27. The module of claim 26 wherein the third interface is configured to power at least one of 12 volt loads and 14 volt loads of the low voltage loads.

28. The module of claim 27 wherein the fourth interface is configured to power at least one of 36 volt loads and 42 volt loads of the high voltage loads.

29. The module of claim 28 further comprising a container having a base and a cover.

30. The module of claim 28 wherein the module is configured for coupling to a vehicle communications network

31. The module of claim 29 wherein the switch is coupled to an exterior of the container and is configured for manual activation.

32. The module of claim 31 wherein the switch is a hinged switch.

33. The module of claim 31 wherein the switch a toggle switch.
